(19) United States
(12) Patent Application Publication
(10) Pub. No.: US 2010/0143015 A1
(43) Pub. Date: Jun. 10, 2010

(54) Sheet processing apparatus and image formation system provided with the same

(75) Inventors: Ichitaro Kubota, Minamikoma-gun (JP); Eiji Fukasawa, Minamikoma-gun (JP); Kenichi Matsuno, Kofu-shi (JP)

Correspondence Address: KANESAKA BERNER AND PARTNERS LLP, 1700 DIAGONAL RD, SUITE 310, ALEXANDRIA, VA, 22314-2848, US

(73) Assignee: NISCA CORPORATION, Minamikoma-gun (JP)

(21) Appl. No.: 12/591,685

(22) Filed: Nov. 30, 2009

(30) Foreign Application Priority Data
Dec. 9, 2008 (JP) 2008-313596
Dec. 9, 2008 (JP) 2008-313715

(51) Int. Cl. G03G 15/00; B41F 13/56

(52) U.S. Cl. 399/407; 270/58.07

(57) ABSTRACT

The invention is to provide a sheet processing apparatus enabling a piled amount of debris paper scraps in a debris storage box to be detected accurately in a simplified mechanism in performing cutting processing on sheets, and the sheet processing apparatus is provided with an apparatus frame, sheet processing means disposed in the apparatus frame to perform cutting such as punching and trimming on a transported sheet, debris storage box for storing paper debris generated in the sheet processing means, and debris amount detecting means for detecting a debris amount inside the debris storage box, where the debris storage box is supported by the apparatus frame to be able to move to positions between an installation position for storing the paper debris and a non-installation position for removing stored paper debris in an orthogonal direction to a transport direction of the transported sheet, and the debris amount detecting means is formed of a pair of sensors arranged to oppose each other in positions for enabling the sensors to detect a debris amount piled inside the debris storage box present in the installation position in the orthogonal direction to the transport direction of the transported sheet.

### BACKGROUND OF THE INVENTION

The present invention relates to a sheet processing apparatus for performing cutting processing such as punching and trimming on sheets, and an image formation system provided with the apparatus, and more particularly, to improvements in a debris storage structure for storing paper debris generated in a processing section.

Generally, a processing apparatus for forming punched holes for filing on image-formed sheets have widely been known as a post-processing apparatus installed in an image formation apparatus. For example, Patent Document 1 discloses an apparatus provided with a punch apparatus disposed in a path for guiding a sheet to a discharge stacker to punch holes in the sheet with an image formed thereon carried out of a copier in the process of discharging the sheet. Such a post-processing apparatus in the image formation system, various apparatuses are proposed to form punched holes in an image-formed sheet or cut the sheet for trimming.

In such an apparatus, when cutting processing is performed on sheets such as punching, trimming cut, etc. required is a mechanism for removing cutting debris (paper scraps). Therefore, in a punch apparatus disclosed in Japanese Laid-Open Patent Publication No. S63-212499 [Patent Document 1] and Japanese Laid-Open Patent Publication No. H07-136993 [Patent Document 2], a debris box is provided under a punch mechanism, and is supported by an apparatus frame to enable the box to be pulled out. Then, for the debris box, a full detecting mechanism is proposed where a longitudinal sensor detects paper scraps collected inside the box.

As described above, when sheets are subjected to cutting processing (punching processing, trimming processing, etc. is collectively called “cutting processing”) by a punch unit, trimming unit or the like, removal of debris paper scraps becomes a problem. For example, in the case of a punch apparatus for punching punched holes in sheets, debris paper scraps are stored in a collection box such as a debris box, and the collection box is configured to be able to move to positions between an installation position (processing position) inside the apparatus and a non-installation position outside the apparatus.

Thus, in the case of adopting the paper debris collecting mechanism for providing a storage box under the processing section of punching, cutting, etc. and storing debris paper scraps in the box to remove to the outside of the apparatus, the following inconvenience arises. First, the debris paper scraps sometime overflow from the debris storage box. In this case, debris paper scraps overflowing from the storage box adhere to a processing sheet or leak into a sheet transport path. At this point, when the debris paper scrap adheres to a sheet, the scrap becomes a cause of degrading the final finished quality. Further, when the debris paper scrap flows into the transport path of the sheet, the scrap results in a malfunction of a sheet sensor or the like, and becomes a cause of a sheet jam, etc.

Concurrently with the problem of an overflow of debris paper scraps, unless the storage box is located in a normal position such as immediately below the processing position, debris paper scraps are not stored inside the box, and cause a problem that the scraps are scattered inside the apparatus.

Conventionally, to solve the above-mentioned problems, the detection mechanism of full detection or near-full detection sensor is devised to accurately detect a piled amount of debris paper scraps stored in the storage box. Further, as well as this detection sensor, a position detection sensor is provided to detect whether or not the debris storage box is installed in a correct position.

Then, as a method of detecting a piled amount of debris paper scraps stored inside the box, in any of Patent Documents 1 and 2 as described above, a pair of detection sensors are arranged to oppose in the orthogonal direction to the pull direction of the debris storage box, detect the top of the debris mountain or a halfway portion of the debris mountain, and thereby detect a piled amount of the debris paper scraps.

However, for example, in the punch unit, the number of punched holes and distance between the holes vary with destination countries such as two-hole punch, three-hole punch, four-hole punch, and six-hole punch as shown in FIG. 8. Therefore, in the detection method as described in Patent Documents 1 and 2, it is required to install a pair of detection sensors in optimal positions for the debris box in accordance with punching hole specifications for the destination country, and as a result, there are defects that assembly control becomes complicated and the like.

Further, the punch unit of punching specifications of portions where punching holes are filled in black can be shared as a two-hole punch using two inner holes in four-hole punching. In this case, the state of the debris mountain varies corresponding to whether the unit is used as a four-hole punch or two-hole punch and its usage frequency. As a result, in the detection method in Patent Documents 1 and 2 as described above, the state of the debris mountain cannot be grasped, and it is not possible to detect a correct debris piled amount.

Furthermore, as in Patent Document 1 described above, by providing the sensor to detect whether or not the debris storage box is installed in a correct position separately from the debris detection sensor, the sensing mechanism results in increases in cost and in size.

It is a main object of the present invention to provide a sheet processing apparatus provided with a plurality of sheet cutting processing modes and with a detection mechanism enabling a piled amount of debris paper scraps to be detected accurately in a simplified mechanism.

Further, it is a second object of the invention to provide a sheet processing apparatus for sharing a sensor for detecting the piled amount of debris paper scraps, and thereby enabling detection of an installation state in an installation position of a debris storage box.

### BRIEF SUMMARY OF THE INVENTION

To attain the above-mentioned main object, a sheet processing apparatus of the invention has an apparatus frame, a sheet processing means disposed in the apparatus frame to perform cutting such as punching and trimming on a transported sheet, a debris storage box for storing paper debris generated in the sheet processing means, and a debris amount detecting means for detecting a debris amount inside the debris storage box, where the debris storage box is supported by the apparatus frame to be able to move to positions between an installation position for storing the paper debris and a non-installation position for removing stored paper debris in an orthogonal direction to a transport direction of the transported sheet, and the debris amount detecting means is formed of a pair of sensors arranged to oppose each other in positions for enabling the sensors to detect a debris amount piled inside the debris storage box present in the installation position in the orthogonal direction to the transport direction of the transported sheet.

Further, to attain the above-mentioned second object, the sheet processing apparatus of the invention is configured that the pair of sensors are formed of a light emitting device and a light receiving device arranged to oppose each other constituting a sensor for detecting an object inside a predetermined sensing area, and a shield member for shielding sensing light between the light emitting device and the light receiving device, and that the shield member shields sensing light between the light emitting device and the light receiving device in synchronization with movement of the debris storage box between the installation position and a detaching position.

The present invention is to support the debris storage box by the apparatus frame to be able to move to positions between the installation position for storing the paper debris and the non-installation position for removing stored paper debris in the orthogonal direction to the transport direction of the transported sheet, while forming the debris amount detecting means using a pair of sensors arranged to oppose each other in positions for enabling the sensors to detect a debris amount piled inside the debris storage box present in the installation position in the orthogonal direction to the transport direction of the transported sheet, and therefore, has the following effects.

First, in the invention, three directions are set at the same direction i.e. the direction of a punching line for punching a plurality of punched holes, the detaching direction of the debris storage box, and the sensing area (detection direction) of the debris paper scraps, the light emitting device and the light receiving device are thus arranged in the same direction as the punching line direction, and are able to detect a full or near-full position through debris paper scraps piled in the shape of a plurality of mountains, and it is thereby possible to perform detection using a common debris storage box and debris amount detecting means irrespective of punching hole specifications varying with destination countries. Accordingly, it is possible to perform accurate detection with a simplified mechanism, and further, to remarkably enhance apparatus production efficiency.

Further, in the case of sharing a four-hole punch as a two-hole punch, even when the state of debris mountains is changed according to the use frequency, the state of debris mountains can be grasped using a pair of sensors, and it is possible to detect an accurate debris piled amount.

Furthermore, in the invention, detection of a debris amount piled in the storage box and detection of whether or not the debris storage box is located in the installation position is set in the sensing area of a single sensor, and therefore, the single sensor is capable of detecting the installation position of the storage box and the debris amount piled inside the box. It is thus possible to configure the detection mechanism with a simplified structure at low cost, and similarly, the control configuration such as a determination circuit, etc. can be configured simply.

### BRIEF DESCRIPTION OF THE SEVERAL VIEWS OF THE DRAWINGS

FIG. 1 is an entire configuration explanatory view of an image formation system according to the invention;

FIG. 2 is an arrangement explanatory view of a sheet processing apparatus in the apparatus of FIG. 1;

FIG. 3 is a longitudinal sectional view of the sheet processing apparatus according to the invention;

FIG. 4 is a sectional side elevation of the apparatus of FIG. 3;

FIG. 5 is a perspective view of a debris storage box in the apparatus of FIG. 3;

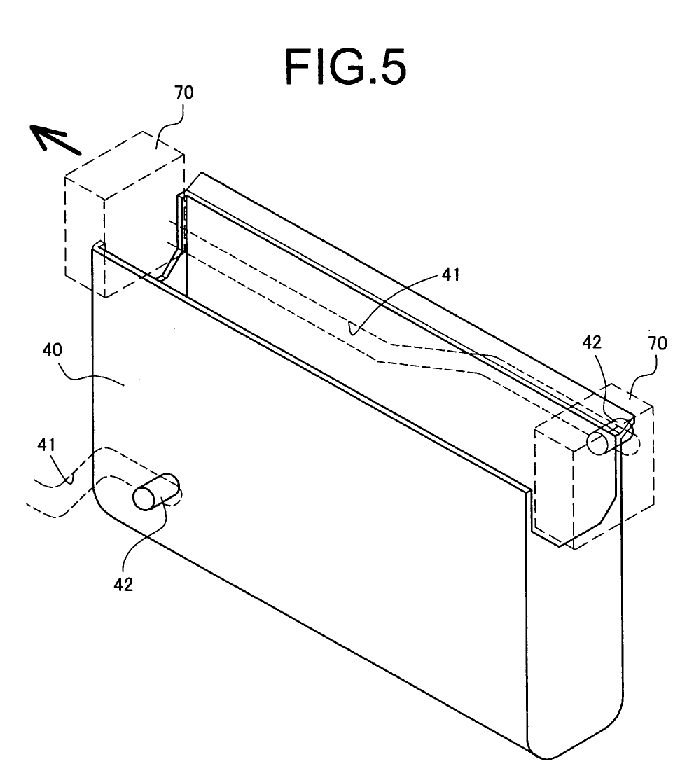

FIG. 6 contains views of the relationship between the debris storage box and debris amount detecting means, where FIG. 6A shows an installation state of the box, and FIG. 6B shows a non-installation state;

FIG. 7 is a block diagram illustrating a control configuration of the image formation system according to the invention; and

FIG. 8 is an explanatory view to explain types of punch units and distances between punching holes.

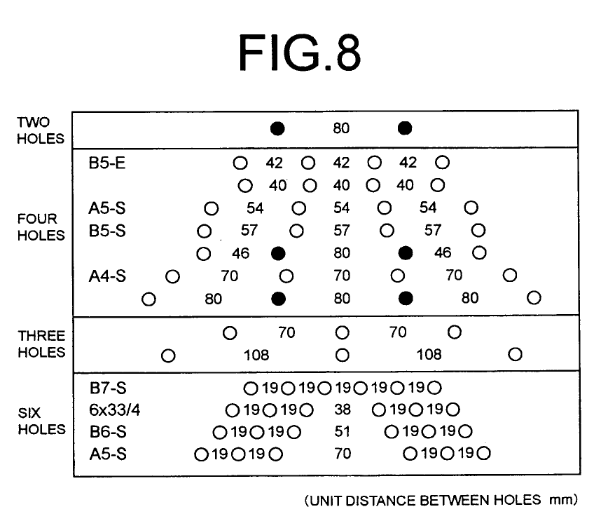

### DETAILED DESCRIPTION OF THE INVENTION

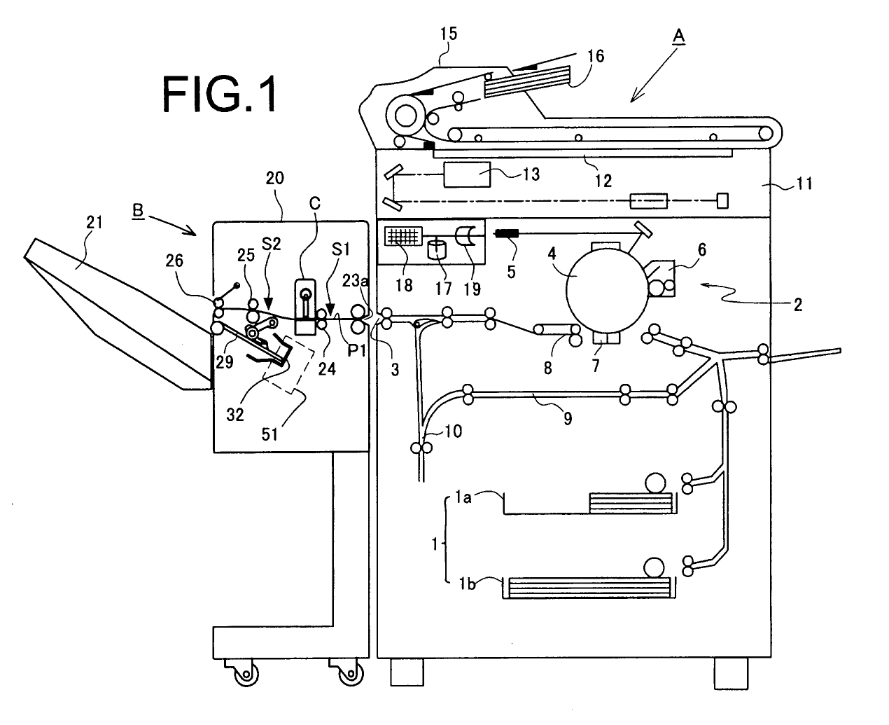

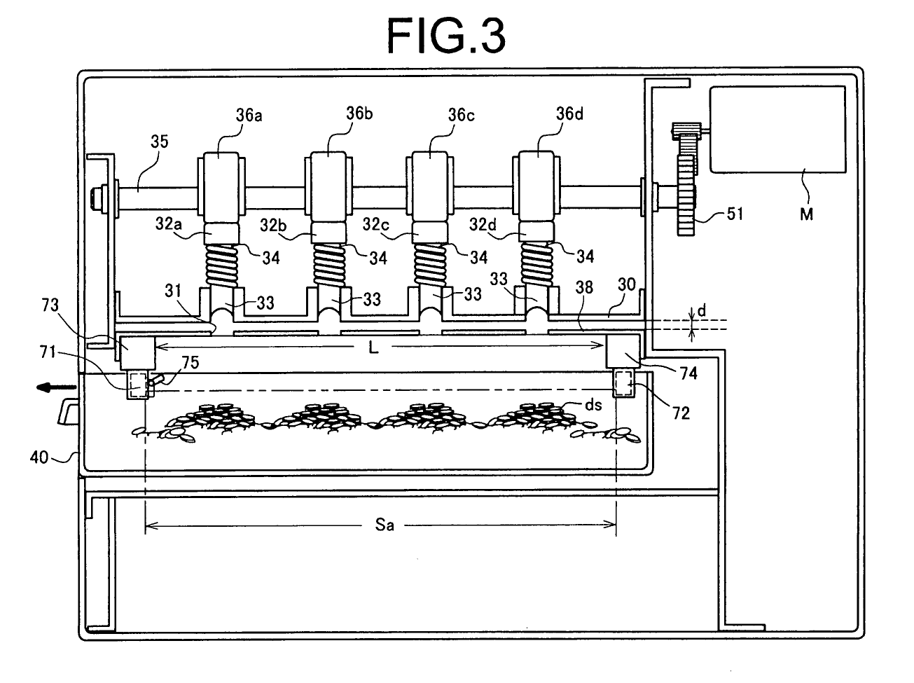

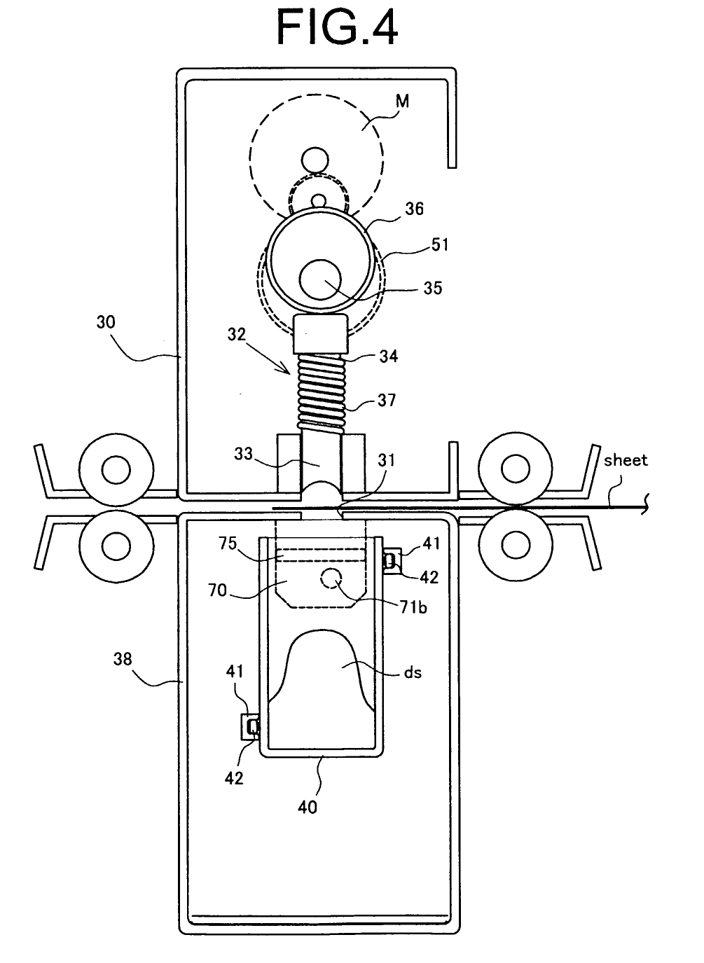

The present invention will specifically be described below according to preferred embodiments shown in drawings. FIG. 1 shows an entire configuration of an image formation system according to the invention, where a sheet processing apparatus is internally provided as a unit. FIGS. 3 and 4 are configuration explanatory views of the sheet processing apparatus.

### [Image Formation System]

An image formation system as shown in FIG. 1 is formed of an image formation apparatus A and post-processing apparatus B, and a sheet-processing apparatus C is built into the post-processing apparatus B as a punch unit. Then, a carry-in entrance 23a of the post-processing apparatus B is coupled to a sheet discharge outlet 3 of the image formation apparatus A, and it is configured that sheets with images formed thereon in the image formation apparatus A are stapled in the post-processing apparatus B and stored in a stack tray 21. The punch unit (sheet processing apparatus; which is the same in the following description) C is disposed in a sheet carry-in path P1 as a unit for forming at least two or more filing holes in a transported sheet in the approximately orthogonal direction to the transport direction of the transported sheet supplied to the carry-in entrance 23a.

### [Image Formation Apparatus]

As shown in FIG. 1, the image formation apparatus A is configured so that a sheet is fed to an image formation section 2 from a sheet feeding section 1, printed in the image formation section 2, and discharged from the sheet discharge outlet 3. In the sheet feeding section 1, sheets with different sizes are stored in 1a and 1b, and designated sheets are separated on a sheet basis and fed to the image formation section 2. In the image formation section 2 are arranged, for example, an electrostatic drum 4, and a print head (laser emitter) 5, developer 6, transfer charger 7 and fuser 8 disposed around the drum, an electrostatic latent image is formed on the electrostatic drum with the laser emitter 5, the developer 6 adds toner to the image, and the image is transferred onto the sheet with the transfer charger 7, and heated and fused with the fuser 8. The sheet with the image thus formed is sequentially carried out from the sheet discharge outlet 3. Reference numeral 9 shown in the figure denotes a circulating path, and is a path for two-side printing for reversing the side of the sheet with printing on its front side from the fuser 8 via a switch-back path 10, and feeding the sheet again to the image formation section 2 so as to print on the back side of the sheet. The side of the two-side printed sheet is reversed in the switch-back path 10, and the sheet is carried out from the sheet discharge outlet 3.

Reference numeral 11 shown in the figure denotes an image reading apparatus, where an original document sheet set on a platen 12 is scanned with a scan unit 13, and electrically read with a photoelectric conversion element not shown. The image data is subjected to, for example, digital processing in an image processing section, and then transferred to a data storing section (not shown), and an image signal is sent to the laser emitter 5. Further, reference numeral 15 shown in the figure is an original document feeding apparatus, and is a feeder apparatus for feeding an original document sheet stored in a paper tray 16 to the platen 12.

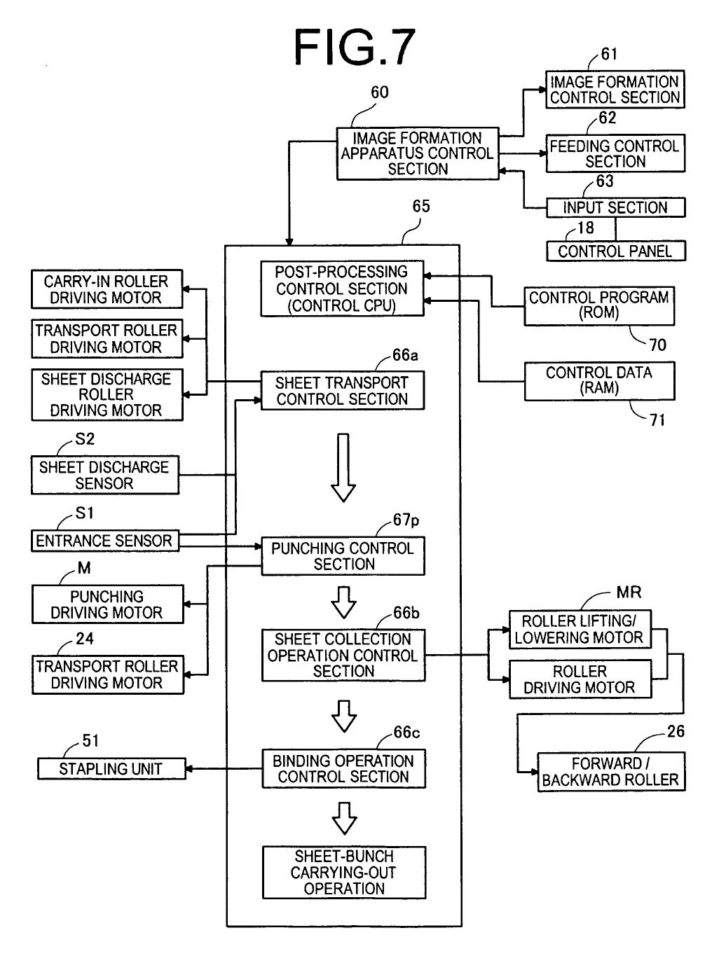

The image formation apparatus A with the above-mentioned configuration is set for image formation/printing conditions such as, for example, sheet size designation, color/monochrome printing designation, number-of-printed sheet designation, one-side/two-side printing designation, scaling printing designation and the like from a control panel 18 provided with a control section 60 as shown in FIG. 7. Meanwhile, it is configured in the image formation apparatus A that image data read by the scan unit 13 or image data transferred from an external network is stored in a data storing section 17, the image data is transferred to a buffer memory 19 from the data storing section 17, and that a data signal is sequentially output to the laser emitter 5 from the buffer memory 19.

A post-processing condition is also input and designated from the control panel 18, concurrently with the image formation conditions such as one-side/two-side printing, scaling printing, monochrome/color printing and the like. Selected as the post-processing condition is, for example, a “print-outmode”, “binding finish mode”, “punching finish mode” or the like.

### [Configuration of the Post-Processing Apparatus]

The post-processing apparatus B receives a sheet with the image formed thereon from the sheet discharge outlet 3 of the image formation apparatus A, and is set for (i) storing the sheet in a stack tray 21 (“print-out mode” as described above), (ii) collecting sheets from the sheet discharge outlet 3 in bunch form for each set to staple, and storing in the stack tray 21 (“binding finish mode” as described above), or (iii) punching a punched hole in the processing (“punching finish mode” as described above). Each configuration will be described below.

A casing 20 of the post-processing apparatus B is provided with the carry-in entrance 23a, and the carry-in entrance 23a is coupled to the sheet discharge outlet 3 of the image formation apparatus A. In the casing 20 is provided a processing tray 29 for collecting sheets from the carry-in entrance 23a for each set to staple and bind. Therefore, the carry-in entrance 23a is provided with the sheet carry-in path P1, and the sheet carry-in path P1 as shown in the figure is disposed in the substantially horizontal direction in the casing 20. Then, the sheet processing tray 29 is disposed to form a level difference on the downstream side of the sheet carry-in path P1. The sheet carry-in path P1 is provided with an entrance sensor S1, sheet transport roller 24, sheet discharge roller 25 and sheet discharge sensor S2. Then, the punch unit C described below is disposed in the sheet carry-in path P1.

### [Configuration of the Punch Unit]

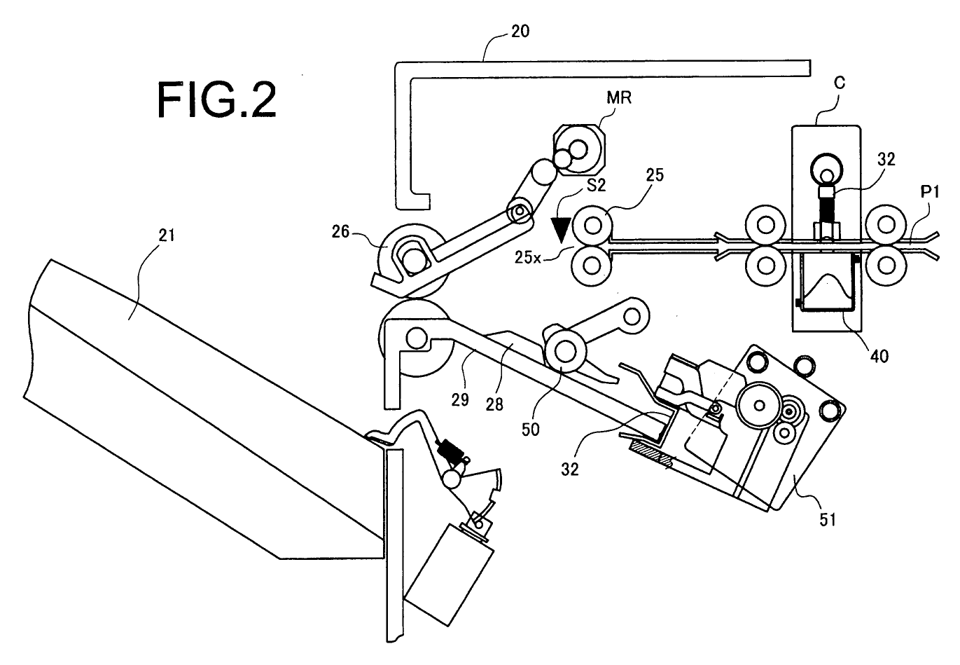

As shown in FIG. 2, the punch unit C is disposed in the sheet carry-in path P1. FIG. 3 shows a longitudinal sectional view of the apparatus, and FIG. 4 shows a cross-sectional view in the direction different from that in FIG. 3. As shown in FIG. 3, the punch unit C is formed of an upper frame 30 and a lower frame 38 having a distance d through which a punching sheet S is passed, punching members 32 installed in the upper frame 30, and dies (blade receiving holes) 31 installed in the lower frame 38.

The upper frame 30 and lower frame 38 are formed in length and dimensions corresponding to the width size of a punching-target sheet S, and the punching members 32 provided in the upper frame 30 form the predetermined number of punched holes in the sheet transported along the lower frame 38. Therefore, each punching member 32 is configured in cylindrical form, and is provided at its front end with a punching blade 33. A plurality of punching members 32 is spaced a distance corresponding to predetermined specifications (file-hole specifications) in the upper frame 30 for two holes, three holes, four holes, etc. in accordance with apparatus specifications. In the members as shown in the figure, a first punching member 32a, second punching member 32b, third punching member 32c and fourth punching member 32d are disposed in four portions so as to selectively punch two punched holes or four punched holes in a sheet.

### [Configuration of the Punching Member]

Each of the punching members 32a to 32d described above is formed of the same structure, and one of the members will be described. The punching member 32 is formed of a punch shaft 34, and a punching blade 33 provided at the front end of the shaft. The punching member 32 is comprised of the rod-shape punch shaft of an appropriate length made of carbon steel, cemented carbide or the like, and the punching blade formed at the front end of the shaft. The blade front end surface of the punching blade 33 is formed in circular shape, and formed in angle-cut shape forming a wave-shaped concavo-convex portion in the circumference direction. Then, the punch shaft 34 is supported by the upper frame 30 to be able to reciprocate. The bearing structure is shown in FIG. 4.

As shown in FIG. 4, the upper frame 30 is formed of a channel member of section in the shape of a C, and each punching member 32 reciprocates up and down by a predetermined stroke. Then, the upper frame 30 is provided with a driving rotary shaft 35, and driving cams 36a, 36b, 36c, 36d are integrally attached to the driving rotary shaft 35. Each driving cam 36 is arranged to engage in a head portion of a respective punch shaft 34. Reference numerals 37a to 37d shown in the figure are return springs. Accordingly, when the driving rotary shaft 35 is rotated by a driving motor M, the driving cam 36 rotates, and the punch shaft 34 engaged with the cam moves downward against the return spring 37. Thus, a plurality of punching members 32 arranged in line form is supported by the apparatus frame (upper frame 30) to reciprocate between the top dead center and the bottom dead center, and moves downward from the top dead center to the bottom dead center by rotation of the driving motor M. By the downward operation from the top dead center to the bottom dead center, a predetermined number of punched holes are formed in the sheet, and the punching members return to the top dead center from the bottom dead center by the return springs 37.

The lower frame 38 is spaced a distance d apart from the upper frame 30 to oppose, and is provided with the blade receiving holes (dies) 31 fitting the punching blades 33 of the punching members 32. In the process during which the punching blades 33 are fitted with the blade receiving holes 33, punched holes are formed in the sheet, and paper debris ds fall to below the blade receiving holes 31.

Then, in the lower frame 38 is disposed a debris storage box 40 to store paper debris ds dropping from the blade receiving holes 31. Therefore, the debris storage box 40 is configured in dimensional shape suitable for the arrangement dimensions (FIG. 3L) of the punching members 32, and is configured to be able to move to positions along a guide rail 41 formed between the box and the apparatus frame to be movable in the direction shown by the arrow in FIG. 3 (direction approximately parallel with the formation direction of at least two or more punched holes punched by the punching members 32, in the approximately orthogonal direction to the transport direction of a transported sheet). Thus, the blade receiving holes 31 of a plurality of punching members 32 arranged in line form are provided with the debris storage box 40, and this debris storage box 40 is attached to the apparatus frame to be able to move to positions in the arrangement direction (the lateral direction in FIG. 3) of the punching members 32. Then, the debris storage box 40 stores paper debris dropping from the blade receiving holes 31 above the box in the installation state as shown in FIG. 3, and by being pulled out in the arrow direction in the figure, can be removed to the outside of the casing 20.

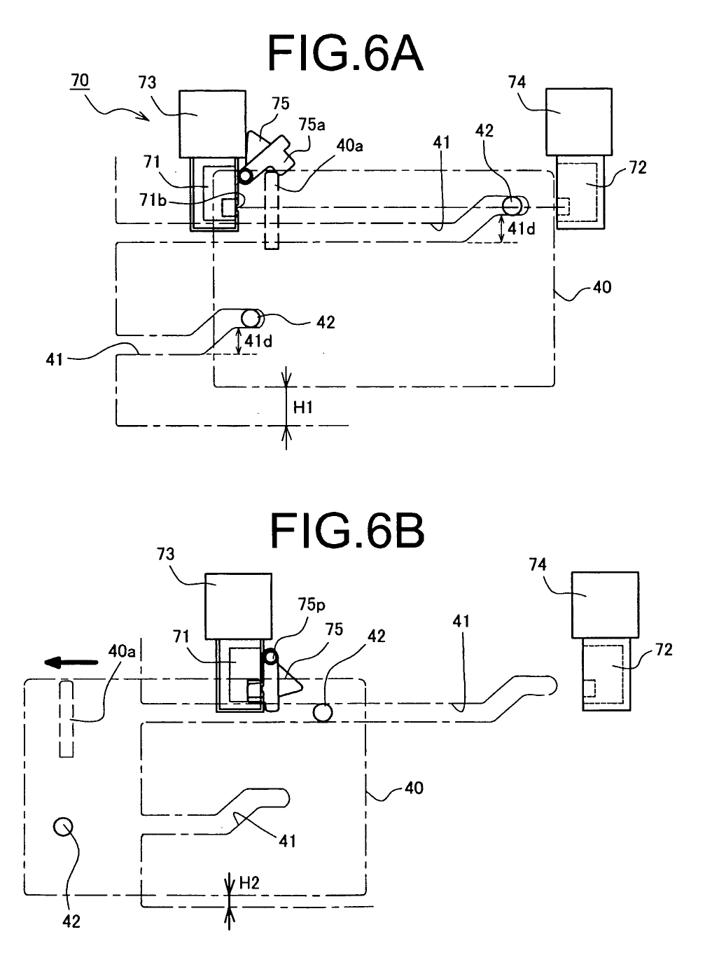

In the apparatus shown in the figure, the guide rail 41 and slider 42 are disposed between the debris storage box 40 and the apparatus frame. In this case, a level difference 41d is formed in the guide rail 41. The level difference 41d is to change the position of the debris storage box 40 between a high position H1 and a low position H2. In other words, in the installation position as shown in FIGS. 6A and 6B, the position of the debris storage box 40 is held in the high position H1. When the box 40 moves from the installation position to the non-installation position, the position of the box 40 is held in the low position H2. The reason why the height difference (level difference 41d) is formed in the guide rail 41 is to prevent a debris amount detecting means 70 described later from colliding against the wall face of the debris storage box 40, by changing the height position of the debris storage box 40 from the high position H1 to the low position H2 when the debris storage box is moved from the installation position to the non-installation position.

The present invention is characterized in that the debris amount detecting means 70 for detecting a piled amount of paper debris ds stored in the debris storage box 40 is disposed as described below. A sensor (debris amount detecting means) 70 is disposed to detect an object such as paper debris inside the debris storage box 40. The means shown in the figure is provided with a pair of transmitting device (light, ultrasonic wave, etc.) 71 and receiving device 72 forming a predetermined sensing area (sensing line; which is the same in the following description) Sa inside the debris storage box 40 located in the installation position as shown in FIG. 3. In the means as shown in the figure, a first bracket 73 and a second bracket 74 are formed from the lower frame 38 and spaced a distance L1 apart from each other to oppose. The transmitting device (light emitting device/light emitting diode) 71 is attached to the first bracket 73, and the receiving device (light receiving device/light receiving sensor) 72 is attached to the second bracket 74. Then, this pair of light emitting diode 71 and light receiving sensor 72 form the sensing area Sa, and detect the presence or absence of an object of cutting off the light (or ultrasonic wave) inside the sensing area.

Between the light emitting diode (transmitting device) 71 and the light receiving sensor (receiving device) 72 is provided a shield member (shutter plate) 75 for shielding the light (or ultrasonic wave), and this shield member 75 enables the light receiving sensor (receiving device) 72 to sense whether or not the debris storage box 40 is located in the installation position. Therefore, the shutter plate 75 is rotatably supported by a shaft pin 75p in the first bracket 73 on the transmitting device side, and is attached to open and close a light applying opening 71b of the light emitting device 71. Then, the shutter plate 75 has an integrally-formed open/close arm 75a. By the open/close arm 75a, when the shutter plate 75 is rotated in the counterclockwise direction in FIG. 6A, the light applying opening 71b is opened, while when the plate 75 is rotated in the clockwise direction, the light applying opening 71b is closed.

Then, an operating piece 40a engaging in the open/close arm 75a is provided in the debris storage box 40. The operating piece 40a integrally formed in the debris storage box 40 opens the light applying opening 71b in the installation position, while closing the light applying opening 71b in non-installation positions other than the installation position. Accordingly, when the paper debris ds exist in the sensing area Sa and the sensing light is shielded by the shield member 75, the light receiving sensor (receiving device) 72 is “OFF”, and detects such a state. Therefore, when a control CPU 65 electrically connected to the light receiving sensor (receiving device) 72 applies a current to the light emitting device (transmitting device) 71 and the light receiving device (receiving device) 72 is “ON”, the CPU 65 judges a state (normal operating state) that the debris storage box 40 is located in the installation position, and that concurrently, paper debris are not present inside the sensing area (sensing line) Sa. Further, when the light receiving device (receiving device) 72 is “OFF”, the CPU 65 judges a state (abnormal operating state) that the debris storage box 40 is not located in the installation position (removal state or failure in setting) or paper debris ds are present (full or near full) inside the sensing area (line) Sa.

In thus configured determining means, when determining that the state is an abnormal operating state, the means urges the operator to perform “operation of setting the debris storage box in the installation position” or “operation of removing paper scraps of the debris box”.

As described above, the invention enables detection of a full state (piled amount) of paper debris inside the debris storage box 40, and concurrently enables whether or not the debris storage box 40 is located in the installation position capable of storing paper debris to be detected, using a pair of detection sensors, for example, the light emitting device (transmitting device) 71 and light receiving device (receiving device) 72.

Further, the invention is characterized in that the sensing area (sensing line) Sa formed by the light emitting device (transmitting device) 71 and light receiving device (receiving device) 72 is set in the direction in accordance with the arrangement line in which a plurality of punching members is arranged, and that the debris storage box 40 is supported slidably in the sensing-line direction.

### [Configuration of the Control Section]

A control configuration of the image formation system as described above will be described below according to a block diagram of FIG. 7. The image formation system as shown in FIG. 1 is provided with a control section (hereinafter referred to as a “main body control section”) 60 of the image formation apparatus A and a control section (hereafter referred to as a “post-processing control section”) 65 of the post-processing apparatus B. The main body control section 60 is provided with an image formation control section 61, feeding control section 62 and input section 63. Then, the settings of “image formation mode” and “post-processing mode” are made from the control panel 18 provided in the input section 63. As described previously, the image formation mode is to set image formation conditions such as the number of print out sets, sheet size, color/monochrome printing, scaling printing, one-side/two-side printing and others. Then, the main body control section 60 controls the image formation control section 61 and feeding control section 62 corresponding to the set image formation conditions, forms an image on a predetermined sheet, and then, sequentially carries out the sheet from the main-body sheet discharge outlet 3.

The post-processing control section 65 is provided with the control CPU 65 for operating the post-processing apparatus B corresponding to the designated finish mode, ROM 70 for storing an operation program, and RAM 71 for storing control data. Then, the control CPU 65 is comprised of a “sheet transport control section 66a” for executing transport of a sheet sent to the carry-in entrance 23a, “punching control section 67p” for punching punched holes in a sheet from the image formation apparatus A, “sheet collection operation control section 66b” for controlling collection of sheets for each set to the processing tray 29, and “binding operation control section 66c” for performing binding processing on a bunch of sheets collected on the processing tray 29.

### [Sheet Transport Control Section]

The sheet transport control section 66a is coupled to a control circuit of a driving motor (not shown) of the sheet discharge roller 25 of the sheet carry-in path P1, and is configured to receive a detection signal from the entrance sensor S1 disposed in this sheet carry-in path P1. The sheet transport control section 66a transports a sheet from the carry-in entrance 23a toward the sheet discharge outlet 25x using the transport roller 24 and sheet discharge roller 25. At this point, when the post-processing mode is the “punching mode”, the punch unit C inside the sheet carry-in path punches punched holes.

### [Punching Control Section]

The punching control section 67p is configured to punch punched holes in a sheet guided to the sheet carry-in path P1 when the post-processing mode is set at “punching punched holes in the print-out mode” or “punching punched holes in the end binding finish mode”. Therefore, the punching control section 67p controls the punching driving motor M of the punch unit C, and a driving motor (not shown) of the transport roller 24 for transporting the sheet to the punch unit C. In other words, the punching control section 67p controls the transport roller 24 such that the sheet stops in a predetermined punching processing position using a signal from the entrance sensor S1. At this point, when a signal from the debris amount detecting means 70 is “OFF (abnormal)”, the section 67p issues a warning of “abnormal debris box” or the like, and waits for a signal from the debris amount detecting means 70 to be “ON (normal)”.

Then, when a signal from the debris amount detecting means 70 is “ON”, the punching control section 67p transports the sheet to a predetermined position by the transport roller 24, then halts the transport roller 24, and turns the punching driving motor ON. By this power application control, the punching driving motor M is controlled in position by an encoder not shown, and rotates from the home position by a predetermined amount. By the rotation of the punching driving motor M, the driving cam 51 rotates, and moves the punching members 32 from the top dead center to the bottom dead center. Then, using a home position return signal from the encoder not shown, the punching control 67p re-starts the transport roller 24, and transports the sheet toward the sheet discharge outlet 25x.

### [Sheet Collection Operation Control Section]

The sheet collection operation control section 66b is configured to control a forward/backward roller 26, and a sheet pressing guide 50 when the post-processing mode is set at the “print-out mode” or “end binding finish mode”. The sheet collection operation control section 66b is connected to a driving circuit of a lifting/lowering motor MR provided in the forward/backward roller 26 to collect sheets on the processing tray 29.

Then, the section 66b shifts the forward/backward roller 26 from a standby position to a sheet engagement position by a detection signal from the sheet discharge sensor S2 disposed in the sheet discharge outlet 25x so as to transfer the sheet carried onto the processing tray 29 to the stack tray 21 side. Then, after a lapse of predicted time that the sheet rear end is carried onto the processing tray, the section 66b reverses the forward/backward roller 26 to feed the sheet to a rear-end regulation stopper 32 arranged on the processing tray 29.

Further, the sheet collection operation control section 66b is coupled to a driving circuit of an operating motor (not shown in the figure) of aligning plates 28 disposed on the processing tray 29. Then, the section 66b is configured to align the width of the sheet fed by the forward/backward roller 26 with the aligning plates.

### [Binding Operation Control Section]

The binding operation control section 66c is configured to control a stapling means 51 and bunch carrying-out means (not shown in the figure) when the post-processing mode is set at the “end binding finish mode”.

What is claimed is:

1. A sheet processing apparatus comprising:
an apparatus frame;
sheet processing means disposed in the apparatus frame to perform cutting such as punching and trimming on a transported sheet;
a debris storage box for storing paper debris generated in the sheet processing means; and
debris amount detecting means for detecting a debris amount inside the debris storage box,
wherein the debris storage box is supported by the apparatus frame to be able to move to positions between an installation position for storing the paper debris and anon-installation position for removing stored paper debris in an orthogonal direction to a transport direction of the transported sheet, and
the debris amount detecting means is comprised of a pair of sensors arranged to oppose each other in positions for enabling the sensors to detect a debris amount piled inside the debris storage box present in the installation position in the orthogonal direction to the transport direction of the transported sheet.

2. The sheet processing apparatus according to claim 1, wherein the sheet processing means is comprised of punching means for punching holes in a plurality of portions of the sheet,
collected paper debris are piled in mountain form in a plurality of portions in the debris storage box, and the pair of sensors are arranged to sense through the paper debris in mountain form in the plurality of portions.

3. The sheet processing apparatus according to claim 2, wherein three directions are arranged in accordance with one another, the three directions being a punching processing line of the punching means for punching holes in a plurality of portions of the sheet, the direction of a track rail for guiding the debris storage box between the installation position and the non-installation position, and a direction for sensing through the paper debris in mountain form in the plurality of portions stored in the debris storage box.

4. The sheet processing apparatus according to claim 1, wherein a track rail for guiding the debris storage box to be movable between the installation position and the non-installation position is disposed in at least one of the debris storage box and the apparatus frame, and has an inclined guide face for lowering the debris storage box moving from the installation position to the non-installation position downward in a piled direction of the paper debris by a predetermined amount.

5. The sheet processing apparatus according to claim 1, wherein the pair of sensors are comprised of a light emitting device and a light receiving device arranged to oppose each other constituting a sensor for detecting an object inside a predetermined sensing area, and a shield member for shielding sensing light between the light emitting device and the light receiving device,
the light emitting device and the light receiving device are disposed to be able to detect the debris amount piled inside the debris storage box in the install at ion posit position, and
the shield member shields sensing light between the light emitting device and the light receiving device in synchronization with movement of the debris storage box between the installation position and a detaching position.

6. The sheet processing apparatus according to claim 5, wherein the sensing area is configured to enable detection of the debris amount stored in the debris storage box in the installation position, and further enable detection of whether or not the debris storage box is located in the installation position.

7. The sheet processing apparatus according to claim 1, wherein the sheet processing means is comprised of punching means for punching holes in a plurality of portions of the sheet,
collected paper debris are piled in mountain form in a plurality of portions in the debris storage box, and the debris amount detecting means is comprised of a transmitting device and a receiving device arranged to sense through the paper debris in mountain form in the plurality of portions.

8. An image formation system comprising:
image formation means for forming an image on a sheet sequentially; and
a sheet processing apparatus for performing post-processing on the sheet from the image formation means,
wherein the sheet processing apparatus has an apparatus frame,
sheet processing means disposed in the apparatus frame to perform cutting such as punching and trimming on a transported sheet,
a debris storage box for storing paper debris generated in the sheet processing means, and
debris amount detecting means for detecting a debris amount inside the debris storage box,
the debris storage box is supported by the apparatus frame to be able to move to positions between an installation position for storing the paper debris and a non-installation position for removing stored paper debris in an orthogonal direction to a transport direction of the transported sheet, and
the debris amount detecting means is comprised of a pair of sensors arranged to oppose each other in positions for enabling the sensors to detect a debris amount piled inside the debris storage box present in the installation position in the orthogonal direction to the transport direction of the transported sheet.
